(19) United States
(12) Patent Application Publication
(10) Pub. No.: US 2007/0074674 A1
(43) Pub. Date: Apr. 5, 2007

(54) Storable and portable bathing station

(76) Inventor: Bridget Miller, Farmington, MN (US)

Correspondence Address: EDWIN TARVER, 16830 Ventura Blvd., SUITE 360, Encino, CA, 91436, US

(21) Appl. No.: 11/243,714

(22) Filed: Oct. 4, 2005

(51) Int. Cl. A01K 13/00

(52) U.S. Cl. 119/671

(57) ABSTRACT

A pet washing device that folds up for storage in a small space. The improved storable and portable animal or pet bathing station comprises a tapered bathing floor to which a back wall is hinged. Two side walls hinge outward from the back wall so that when the back wall is opened, the side walls swing outward to form a partial box. An adjustable front wall may be raised and lowered along tracks in the side walls to complete the box and contain the animal. The bathing station includes a hose and spray attachment, and a soap attachment for washing an animal, and drainage mechanism to drain water to a remote location. The station can be folded and latched into a lightweight compact shape and transported with its handle.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to a device for bathing pets or animals of various sizes that is easy to use and clean, and is collapsible for easy storage and transportation.

Pet grooming is frequently performed by commercial pet groomers, which can be expensive. As a less expensive alternative, pets may be washed outdoors with the use of a garden hose. This is not a viable option, however, if the temperature outside is cold, or if the pet owner is living in an apartment where access to an outdoor facility is unavailable.

As another alternative, pet owners may use a bathtub in the home. However, since bathtubs are designed for human use, this method is impractical. It is often difficult to lead the animal into the tub, and a large amount of water may be splashed outside the tub as the animal is bathed.

Stand alone pet bathtubs are known in the art. U.S. Pat. No. 4,987,860 to Davis discloses a small animal bath for automatically washing a cat or small animal. When the animal is placed into the device and the device activated, the animal is sprayed with water, except for its head which fits through an aperture. However this device is overly complex, and results in a panicked animal.

U.S. Pat. No. 5,711,252 to Brandolino discloses a stand-alone pet bath apparatus with a sloped floor unit including an elevated portion, a lower portion and a drain portion located in the lower drain portion. A pair of end wall units and a pair of side wall units are supported by the sloped floor unit with connector assemblies that connect adjacent wall units together. Although similar in construction, this device does permit easy access to the animal being bathed, and doesn't disclose a wall unit that can be raised and lowered for easy ingress or egress of the animal.

U.S. Pat. No. 5,678,511 to Day discloses a bathing device for pets that includes a basin with at least one adjustable strap attached between the sides of the basin. The strap is secured in elongated slots along the sides of the basin over the back of the pet being bathed. A central hump is formed on the basin floor that conforms substantially to the underbelly of the pet. The hump prevents the pet from sitting down during the bathing process. An adjustable collar restraint strap attachable to a pet collar is attached to an additional slot. The pet is immobilized by way of the hump and adjustable straps. A drain with a removable plug is included at the bottom of the basin that is attachable to a standard garden hose for removal of bath water. Since this device does not have movable walls, and is not collapsible, it is difficult to work with and unwieldy in comparison with the present invention.

U.S. Pat. No. 5,974,601 to Drane, et al. discloses a small animal washing container for use in a home bathtub or shower stall. The carrier includes foldable legs to raise it to a height that allows a person to stand while administering the bath. This device is suitable for small animals, however it will not accommodate larger animals, and stands very precariously in a conventional tub. The device also lacks adjustable walls and is not easily portable.

U.S. Pat. No. 6,553,943 to Murphy discloses a pet bathing apparatus wherein a pet stands or sits on a bathing platform which rests on a pedestal structure that supports the platform and provides drainage to the base of the apparatus. This device is also precarious due to its height, and the fact that only a single pedestal is provided for support. The device also has no walls to prevent water from splashing outside the bathing area, and is also not portable.

It is therefore an object of the present invention to provide a storable and portable bathing station for animals or pets. Another object of the present invention is to provide a storable and portable bathing station that is easily collapsible to be stored in a small space when not in use. Another object of the present invention is to provide a storable and portable bathing station for animals or pets that has an adjustable wall for easy ingress and egress of animals from the bathing station. In is also an object of the present invention to provide a storable and portable animal bathing station that functions effectively as a bathing station equipped with holders for sponges, soap and other bathing accessories.

### SUMMARY

The present invention is directed to a lightweight, portable and collapsible pet bathing station for various sized pets. The invention has an opening to allow easy access of the pet into the station by means of an adjustable front door, which can be raised to various heights once the pet is contained in the station.

The front door is adjusted by means of a track on which the front door can be secured into place by means of a latch to be locked by a spring, which can be triggered in the handle of the front door. The front door slides and can be easily lowered and raised, and further can be self contained in the station by means of being rolled up on a rod.

The sides of the station are attached to the back of the station by means of plastic hinges and hinge pins, preferably made of aluminum or other types of non-rusting metal. The sides are further held in place by snap adjustments on the bottom corners of the sides to the front base.

The rear wall contains circular leash holders so that a pet can be secured in the station. The rear wall of the station also contains the following; a cylindrical soap holder, preferably of 4 by 6 inches; and a spray hose holder that houses a spray hose with a nozzle. The leash holder, soap holder and spray holder are constructed such that they can be collapsed to lie flat in order to allow the station to be easily folded. The bottom of the station includes a drain and drain pipe which funnels water to the outside of the station. An outside water source may be connected to the anterior end of the spray hose, and an outside drain line may be connected to the drain via a connector.

The size of the station may vary according to various sizes of animals. The station is preferably constructed of plastic. When the station is collapsed for storage, a latch is included which allows the station to be securely held together. The base of the station includes a no slip covering or non-slip bottom supports so that the station is stable during use. The portion of the drain pipe that is exposed is threaded such that a drain hose may be connected to divert the water to a remote area. Additionally, a portion of the water pipe is also threaded such that a hose may be connected to a water source.

A hose with two connection-to-faucet options is provided in order to connect the water source to the spray hose. The bottom of the base is designed with drip edges on the back and sides such that water is diverted to the drain. Ideally, the station does not exceed eighty pounds for medium to large pets. Finally, the station includes a handle located on the front lower base to allow for easy carrying of the station.

### BRIEF DESCRIPTION OF THE FIGURES

FIG. 1 is a perspective view of the improved bathing station of the present invention when it is unfolded and ready for use, showing only the right half of the adjustable door.

FIG.2 is a side elevational view of the improved bathing station of the present invention.

FIG. 3 is a rear elevational view of the improved bathing station of the present invention

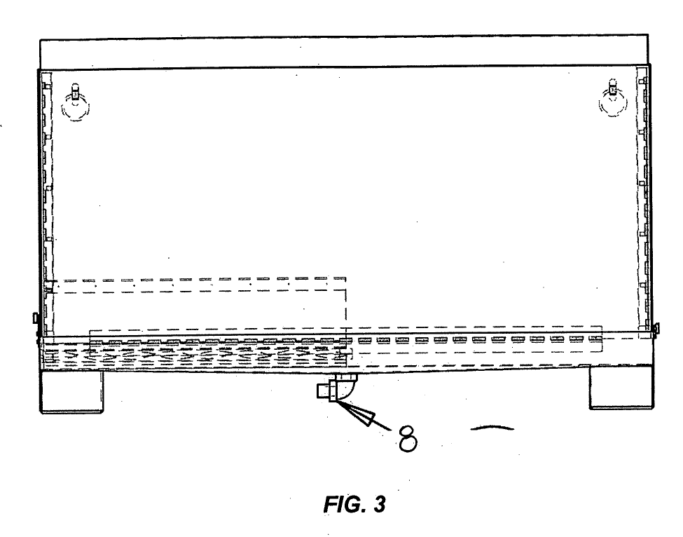

FIG. 4 is an exploded perspective view of the adjustable door of the improved bathing station of the present invention.

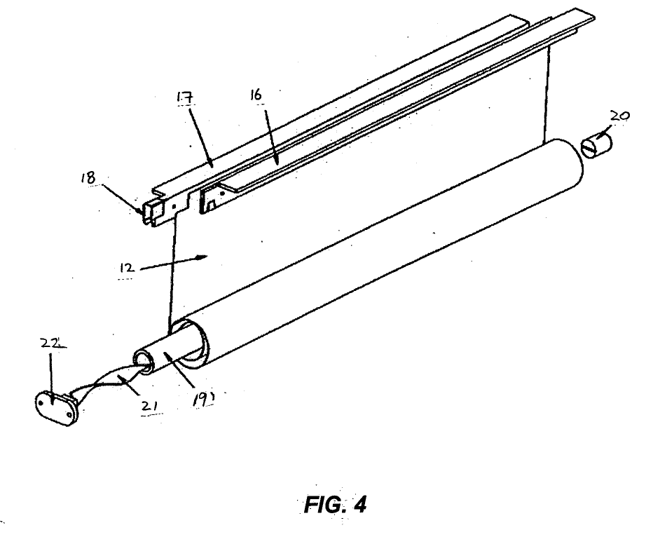

### FIGURES—REFERENCE NUMERALS

1 . . . Base Pan
2 . . . Back Hinge.
3 . . . Back Wall
4 . . . Side Hinge
5 . . . Right Side Wall
6 . . . Support Members
7 . . . Latch Pin
8 . . . Drain Elbow
9 . . . Left Side Wall
10 . . . Latch Lever
11 . . . Leash Ring
12 . . . Adjustable Door
13 . . . Top Lip
14 . . . Center Drain
15 . . . Slotted Tracks
16 . . . Inside Top Angle
17 . . . Outside Top Angle
18 . . . Door Latch Mechanism
19 . . . Door Anchor Rod
20 . . . Torsion Spring Rod Anchor
21 . . . Elastomeric Torsion Spring
22 . . . Torsion Spring Anchors

### DESCRIPTION

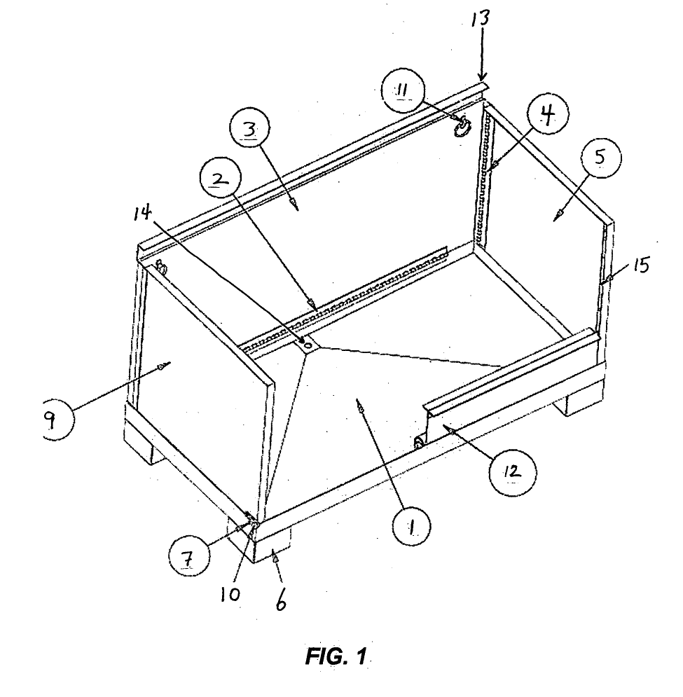

FIG. 1 is a perspective front view of the bathing station of the present invention in an open position ready for use. Referring to FIG. 1, the bathing station comprises a leak proof base pan 1, tapered to a back center drain 14. The base pan 1 has a back hinge 2 attached to the base pan 1 along the back wall 3 of the base pan 1. Several support members 6 attached to the underside of the base pan 1 serve to stiffen the base pan 1, allow clearance for a drain elbow 8 and allow the base pan 1 to be tapered to the center drain 14. The bases of the support members 6 are covered with a non-slip coating (not shown).

The back hinge 2 serves to stiffen the bottom of the back wall 3 and secure it to the base pan 1, as well as establish the folding position of the bathing station when it is not in use. A drain filter (not shown) prevents hair from sluicing through the center drain 14, and is removable for easy cleaning. A 90 degree drain elbow 8 connects to the center drain 14 on the outside of the bathing station, and allows a standard garden hose (not shown) with a threaded connector to be attached with minimal clearance. The garden hose may also be stored in the bathing station when it is not in use.

The surface of the base pan 1 is coated with a non-slip material (not shown) to prevent a pet from slipping as it is being washed. In an alternate embodiment, a non-slip pad is provided in lieu of a non-slip surface on the base pan 1, and the non-slip pad may be stored in the base pan 1 when the bathing station is folded and not in use.

The back wall 3 of the bathing station is of the same general outer dimensions as the base pan 1 so that the back wall 3 fits inside the base pan 1 when the station is folded, except for the top lip of the back wall which fits over the base pan 1. The back wall comprises leash rings 11 in the stiff upper corners to attach a pet leash and restrain pets while they are bathed.

The back wall 3 also comprises a soap holder (not shown) which is collapsible and hangs on the back wall 3, stores in the base pan 1 and can be used with a variety of soap bottles. The back wall 3 further comprises a spray hose and holder (not shown), the hose of which extends through the back wall 3 and connects to a standard laundry faucet. The spray holder holds the spray hose and head during washing. The soap holder, spray hose and spray head may also be incorporated into the side walls of the bathing station.

The back wall 3 connects at either vertical side with left side wall 9 and a right side wall 5. The side walls 5,9 are connected to the back wall 3 with side hinges 4 so that they fold into the back wall 3 when the bathing station is folded and put away. The side hinges 4 also provide stability to the bathing station when it is open. The side walls are angled inward at the top for stability, and contain slotted tracks 15 on the vertical sides opposite the back wall 3, to provide tracking for the adjustable front door 12 and also for stability. The bottom edges of the side walls 5,9 remain inside the base pan 1 when the bathing station is open to provide a drip edge. A latch pin 7 and latch lever 10 mechanism locks the side walls 5,9 in an open position when the bathing station is in use.

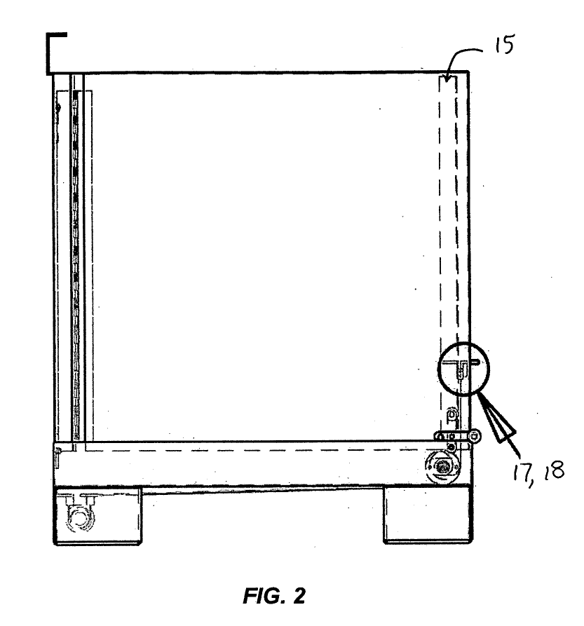

FIG. 2 is a partial perspective view of the adjustable door of the bathing station. Referring to FIG. 2, the adjustable door 16 comprises a thin stiff film such as mylar, PET, or similar material that is resilient to water, but is malleable enough to roll up. The top of the adjustable door 1 is affixed to an inside top angle 17 and an outside top angle 18. The inside top angle 17 and outside top angle 18 are made of metal to stiffen the top of the door 12. The top flanges act as a door handle to allow one hand operation.

The extreme ends of the inside top angle 17 and outside top angle 18 are relieved to run in the slotted tracks 15 of the side walls 5,9. The outside top angle 18 also comprises a spring door latch mechanism 19 that contains a leaf spring to control the rotation of the inside top angle 17 and outside top angle 18 while in the slotted tracks 15, and to act as a release for the door when it is latched in position.

The adjustable door 12 rolls up at the bottom of the bathing station on a door anchor rod 19. The door anchor rod 19 is attached to a torsion spring rod anchor 20, elastomeric torsion spring 21, and torsion spring anchor 22. The door anchor rod 19 establishes a fixed location for the roll up door, stiffens the door bottom and provides space for the elastomeric torsion spring 21. The torsion spring anchors 22, anchor the adjustable door 12 to the base pan 1, provide bearing journals for the rotating anchor rod 19, thereby establishing an axis of rotation, and fix the ends of the torsion spring 21. The torsion spring 21 winds up, and provides torsion to the adjustable door 12. The door anchor rod 19 transmits the torque form the torsion spring 21 to the adjustable door 12.

The bathing station contains a handle and latch assembly (not shown) on the outside of the base pan 1 and back wall 3 to maintain the assembly in a closed position when it is not in use. The handle is used to transport the bathing station

In order to use the bathing station, a person sets the station on its support members on a level surface, unlatches the closed unit, and swings up the back wall from the base pan 90 degrees. The side walls are then swung out from the back wall until they latch into the forward corners of the base pan. A pressurized hose is connected to the spray hose, and a drain hose is connected to the drain if necessary.

A pet is placed in the bathing station and the adjustable door is raised to a preferred height and latched in position. After the pet is cleaned and rinsed, the adjustable door can be lowered with a twist of the door latching handle and the pet removed. Once the adjustable door is back in a retracted position, the hoses may be disconnected and placed in the base pan, the side walls, can be disconnected from the base pan and folded into the back wall, and the back wall can then be folded down onto the base pan and latched into position. The device may then be transported and stored.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

While specific apparatus has been disclosed in the preceding description, it should be understood that these specifics have been given for the purpose of disclosing the principles of the present invention and that many variations thereof will become apparent to those who are versed in the art. Therefore, the scope of the present invention is to be determined by the appended claims.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

What is claimed is:

1. A storable and collapsible pet bathing station comprising;
a quadrilateral base pan, oriented as a horizontal plane comprising front, rear, left and right side edges, and a horizontal surface, wherein the horizontal surface is vertically downwardly sloped for drainage, incorporating a drain hole at its lower terminus, a plurality of support means affixed to the underside of the base pan for vertical support and drainage clearance, an attachment means along the front side edge of the base pan for an adjustable front wall member, and an attachment means along the rear side edge of the base pan for a rear wall member;
a rear wall member oriented as a vertical plane, comprising a top and bottom side length equal to the rear side edge of the base pan, affixed along its bottom side to the rear side of the base pan in a hinged manner, comprising attachment means for side wall members along each vertical side of the rear wall;
a left side wall member oriented as a vertical plane comprising a bottom and top horizontal side length equal to the side edge length of the base pan, and vertical side lengths equal to the height of the rear wall, affixed along one vertical side in a hinged manner to the left vertical side of the rear wall;
a right side wall member oriented as a vertical plane comprising a bottom and top horizontal side length equal to the side edge length of the base pan, and vertical side lengths equal to the height of the rear wall, affixed along one vertical side in a hinged manner to the right vertical side of the rear wall; and
a front wall oriented as a vertical plane, comprising a top and bottom side length equal to the front side edge of the base pan, affixed at each bottom horizontal terminus to a front corner of the base pan, and comprising the ability to be raised or lowered along the forward edges of the side walls opposite the rear wall.

2. The base pan of claim one, wherein each side edge terminates in an upturned vertical lip to prevent liquid from overflowing out of the base pan, and to serve as an attachment surface for the rear wall and front wall.

3. The base pan of claim one, wherein the supports under the base pan, elevate the corners of the base pan higher than the downward sloping terminus of the base pan surface.

4. The base pan of claim one, wherein the lower terminus of the base pan surface is at the middle point along its rear edge.

5. The base pan of claim one, wherein a drain elbow is incorporated into the underside of the drain hole, to allow remote drainage of the bathing station via a connectable hose, including a garden hose

6. The rear wall of claim one, wherein the rear wall comprises leash rings to which an animal leash or tether may be affixed.

7. The rear wall of claim one, wherein the rear wall comprises an enclosure along the length of the top edge to house the collapsed front wall.

8. The side walls of claim one, wherein one vertical side edge is connected to the rear wall in a hinged manner, and the opposing vertical side edge comprises an attachment means, or guide for the raising an lowering of the front wall, including a slotted track with multiple latching means to adjust the height of the front wall.

9. The front wall of claim one, wherein the wall comprises a thick stiff film that rolls up onto a torsion spring anchor rod affixed to a torsion spring assembly comprising a torsion spring anchor, an elastomeric torsion spring, and the torsion spring anchor rod.

10. The front wall of claim one, wherein the extreme ends of the adjustable door are anchored to the front corners of the base pan, including the vertical lips of the base pan.

11. The front wall of claim one, wherein the top of the door comprises an inside top angle and an outside top angle, used to grasp the door and raise it into position along the tracks of the side walls.

12. The front wall of claim 11, wherein the top angles comprise a door latching mechanism on either extreme end serving to affix the door at specific heights along the tracks of the side walls.

13. The base pan of claim one, comprising a latching mechanism at the forward left and right corners of the base pan, to fix the bottom forward corners of the side walls to the base pan to stiffen the device when in the open position.

14. The rear wall of claim 1, wherein the rear wall comprises a hanging soap holder incorporated on its inner surface, a spray hose extending through to its outer surface, connectable to a garden hose, and removably contained in a housing incorporated on the rear wall inner surface.

15. The bathing station of claim one, wherein a handle and latch mechanism is disposed on the outer surface of the device to maintain the bathing station in a folded and closed position when not in use and to carry the bathing station.

16. A method of using an improved storable and portable animal or pet bathing station, comprising the steps of;
setting the bathing station down on its supporting means with the base pan in a horizontally planar position;
unlatching the bathing station and lifting up the rear wall which serves as a lid when the bathing station is in a closed and folded position, until the rear wall is in a vertical position;
swinging each side wall, which are folded into the rear wall when the bathing station is in a closed and folded position, out until the bottom free corners of the side walls latch into the latch lever mechanisms on the front corners of the base pan;
connecting a pressurized hose to the spray hose terminal on the back of the rear wall, and connecting a drain hose to the drain elbow on the underside of the base pan if necessary;
placing an animal in the bathing station, attaching the animal's leash to the leash rings on the bathing station rear wall, and raising the adjustable front wall to a locking position at a preferred height;
bathing and rinsing the animal;
lowering the front wall by unlocking the latching mechanism along the extreme ends of the top side of the front wall, and removing the animal;
disconnecting all hoses, Unlatching the side walls, folding them into the rear wall, folding the rear wall down over the base pan, and latching the bathing station closed.
